(19) United States
(12) Patent Application Publication
(10) Pub. No.: US 2010/0092759 A1
(43) Pub. Date: Apr. 15, 2010

(54) FLUOROPOLYMER/PARTICULATE FILLED PROTECTIVE SHEET

(76) Inventors: Hua Fan, Tyngsboro, MA (US); Keith C. Hong, Northborough, MA (US); Gurkirat S. Sekhon, Northborough, MA (US); Karen Conley, Amesbury, MA (US); Julia DiCorleto Gibson, Bedford, MA (US)

Correspondence Address: Fulbright & Jaworski L. L. P.;ATTN MNIPDOCKET_SAINT GOBAIN CERAMICS AND PLASTICS, 600 Congress Avenue, Suite 2400, Austin, TX, 78701, US

(21) Appl. No.: 12/576,724

(22) Filed: Oct. 9, 2009

Related U.S. Application Data
(60) Provisional application No. 61/104,914, filed on Oct. 13, 2008.
(60) Provisional application No. 61/232,694, filed on Aug. 10, 2009.

(51) Int. Cl. B32B 5/16; B29C 39/12; B29C 35/02; B32B 27/08; C08L 27/12; C08L 27/20

(52) U.S. Cl. 428/323; 264/255; 264/488; 264/483; 428/411.1; 428/422; 428/421; 524/545; 524/546

(57) ABSTRACT

The invention describes a particulate filled film, useful as a backsheet for a photovoltaic construct.

### CROSS REFERENCE TO RELATED APPLICATIONS

This application claims priority and benefit of U.S. Provisional Ser. Nos. 61/104,914 entitled “Fluoropolymer/Particulate Filled Protective Sheet”, filed Oct. 13, 2008 and 61/232,694 entitled “Fluoropolymer Films”, filed Aug. 10, 2009 the contents of which are incorporated in their entirety herein by reference for all purposes.

### FIELD OF THE INVENTION

The invention relates generally to films and multilayer films having at least one particulate embedded into a film, and methods for their manufacture that are useful as packaging materials.

### BACKGROUND OF THE INVENTION

Multilayer films or laminates are constructions which attempt to incorporate the properties of dissimilar layers in order to provide an improved performance versus the materials separately. Desirable properties for multilayer films include moisture vapor barrier, weather resistance, cut through resistance, electrical resistance, surface reflectance, opacity, two-sided color, or other two-sided electromagnetic spectral effects.

Up until the present invention, such laminates often result in a mis-balance of properties, are expensive or difficult to handle or process. Addition of a material to improve one property may result in the concurrent loss of another property.

In the growing field of electronic protective packaging films it is vital to provide a well-tailored, economic balance of desirable properties. For example protective backsheet films for photovoltaics must provide a combination of properties such as protection from moisture, good dielectric strength, high opacity and or/reflectivity. Achieving these properties in a multilayer film has been difficult or expensive.

In particular, achieving property control by the commonly used method of adding a suitable filler has often resulted in the improvement of one property with a drop in another. For example, the addition of a light blocking filler at levels needed to obtain a high level of opacity can result in an undesirable increase in moisture vapor transmission. Similarly, addition of a high level of light blocking filler can result in an undesirable decrease in dielectric strength. In another example, addition of filler to increase reflectivity of a film can result in a multilayer film surface that adheres poorly when bonded within the photovoltaic device. Previous films have generally provided one or two desirable properties of protective films for electronic devices, but have not been able to provide a better level of combined protection.

Furthermore, when fillers are added to melt extruded multilayer films they can be difficult to disperse, requiring considerable mixing, resulting in increases in process time and expense.

Accordingly, there is a need for multilayer films that can be tailored to provide one or more improved properties for a photovoltaic sheet. There is also a need for multilayer films tailored to other protective applications such as protective wrap for wire or cable applications, or protective films for other optoelectronic devices such as OLEDS.

### BRIEF SUMMARY OF THE INVENTION

The present invention surprisingly provides multilayer films, and processes to prepare such multilayer films, that overcome one or more of the disadvantages known in the art. It has been discovered that it is possible to make and use multilayer films having characteristics, for example, suitable for packaging materials for electronic devices. These films help to protect the components from heat, humidity, chemical, radiation, physical damage and general wear and tear. Such packaging materials help to electrically insulate the active components/circuits of the electronic devices. Additionally, such materials provide protective cushioning to electronic devices, such as photovoltaic devices, provide antisoiling properties, chemical resistance, UV resistance, reflectivity, increased flame retardancy, aesthetics and/or opacity.

In one aspect, the present invention provides a casting composition that includes a carrier liquid; a polymer resin matrix material; a particulate filler material; and wherein the polymer matrix material and particulate filler material are included in the composition in relative amounts effective to provide a dry composite film that includes varying percentages of volume percent filler material.

Surprisingly, it has been found that by selecting one or more of the parameters of the particulate filler dimensions, the type of particular filler and/or the volume percentage of filler material, the opacity of the film can be controlled while providing an aesthetically pleasing appearance as well as providing film integrity. Generally, with incorporation of less particulate filler there is an improvement in the integrity of the film while retaining opacity. Lower levels of particulate filler can also provide a lower moisture transmission, or improvements in dielectric strength. Therefore, in certain embodiments, it is preferable to have less than 15 volume percent filler present in the ultimate film.

Interestingly though, it has been found that there is a balancing of factors with the control of the volume percentage of filler. The particle size can also effect the integrity of the film and in some aspects, the operator would choose filler material(s) where none of the single linear dimensions of particle was greater than 10 μm and can be from a nanometer (nm) to about 100 nm, e.g., 0.1 μm. In another aspect, the particulate filler can have a single dimension of from 100 nm to 2 μm In other aspects, some of the particulate filler can have single linear dimensions greater than 10 μm.

Selection of the particulate itself can help enhance the film integrity and physical properties such opacity, water vapor transmission, IR reflectance and dielectric constant. The particulate can be one of, or a mixture, of silica particles, aluminum flakes, glass beads, glass microspheres, glass fibers, titanium dioxide particles, barium titanate particles, calcium carbonate, zinc oxide, mica, clay such as kaolin or others, mullite, talc, iron oxide, carbon black, zinc sulfide, barium sulfate, zinc sulfite, a range of pigments such as cobalt aluminate blue, sodium alumino sulphosilicate, flame retardants such as magnesium hydroxide, antimony trioxide, organophosphates or brominated compounds, or other suitable particulates for the application envisioned. In some embodiments, the particle size can be from about 100 nanometers (nm) to about 2 microns (μm).

In another aspect the particle may be reflective in the infrared or region of the spectrum. Particles of this type can be effective in reducing IR absorption and consequent heat build up in the film, while at the same choice allowing a range of color choices in the visible spectrum. Such IR reflective pigments include Arctic Black 10C909, Black 411, Yellow 193, Brown 12 and Brown 8 from Shepherd Color Company, Cincinnati, Ohio and V-780 Black, V-778 Black, PC-9415 Yellow, V-9248 Blue, V-13810 Red, and V-12600 Camouflage Green from Ferro Corporation, Cleveland Ohio.

In another aspect, the present invention provides films from the casting composition.

In another aspect, the present invention provides methods to prepare the films and multilayer films disclosed herein.

In still another aspect, the present invention provides a photovoltaic device that includes a photovoltaic component protected by (for example, in contact with) a film or multilayer film of the invention.

It should be understood that the multilayer films of the invention can include from 2 layers to about 12 layers of material. For example, the multilayer films can repeat layering of a first layer and a second layer, and so forth. An outer layer or two outer layers can be included in the multilayer film construction. The outer layers, for example, can be a fluoropolymer or a non-fluoropolymer. Additionally, combinations of various layers are included herein, for example, a first layer, a second layer, a third layer differing from the first or second layers and a fourth layer which differs from the first, second or third layers, etc. This layering, again, can be repeated as needed for the application envisioned.

The multilayer films generally have a dielectric break down strength (kV) that is greater than 3 kV measured by ASTM method D3755, a solar reflectance that is greater than 70% measured by ASTM method E424, or a water vapor transmission that is less than 20 g/m²/day measured by ASTM method F1249 when the multilayer film has a thickness between about 0.8 mils and about 2.0 mils, e.g., about 1.1 mils.

The present invention also provides methods to prepare the multilayered films noted throughout the specification.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### DETAILED DESCRIPTION

In the specification and in the claims, the terms “including” and “comprising” are open-ended terms and should be interpreted to mean “including, but not limited to . . . ” These terms encompass the more restrictive terms “consisting essentially of” and “consisting of:”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

The present invention includes various embodiments. In a first embodiment, the invention pertains to a casting composition comprising:

a carrier liquid;

a nonfibrillated non-fluoropolymer or fluoropolymer matrix (a polymer resin or polymer matrix) material;

a particulate filler material wherein some of the particles of the particulate filler material exhibit a single linear dimension greater than 10 μm; and wherein the polymer matrix material and particulate filler material are included in the composition in relative amounts effective to provide a dry composite film including greater than 15 volume percent filler material.

In a second embodiment, the invention pertains to a casting composition comprising:

a carrier liquid;

a nonfibrillated non-fluoropolymer or fluoropolymer matrix material;

a particulate filler material wherein some of the particles of the particulate filler material exhibit a single linear dimension greater than 10 μm; and wherein the polymer matrix material and particulate filler material are included in the composition in relative amounts effective to provide a dry composite film including less than 15 volume percent filler material.

In a third embodiment, the invention pertains to a casting composition comprising:

a carrier liquid;

a nonfibrillated non-fluoropolymer or fluoropolymer matrix material;

a particulate filler material wherein none of the particles of the particulate filler material exhibit a single linear dimension greater than 10 μm; and wherein the polymer matrix material and particulate filler material are included in the composition in relative amounts effective to provide a dry composite film including less than 15 volume percent filler material.

In a fourth embodiment, the present invention pertains to a casting composition comprising:

a carrier liquid;

a nonfibrillated non-fluoropolymer or fluoropolymer matrix material;

a particulate filler material wherein some of the particles of the particulate filler material exhibit a single linear dimension greater than 10 μm; and wherein the polymer matrix material and particulate filler material are included in the composition in relative amounts effective to provide a dry composite film including greater than 15 volume percent filler material.

In a fifth embodiment, the present invention pertains to a casting composition comprising:

a carrier liquid;

a nonfibrillated non-fluoropolymer or fluoropolymer matrix material;

a particulate filler material wherein some of the particles of the particulate filler material exhibit a single linear dimension greater than 10 μm; and wherein the polymer matrix material and particulate filler material are included in the composition in relative amounts effective to provide a dry composite film including less than 15 volume percent filler material.

In a sixth embodiment, the present invention pertains to a casting composition comprising:

a carrier liquid;

a nonfibrillated non-fluoropolymer or fluoropolymer matrix material;

a particulate filler material wherein none of the particles of the particulate filler material exhibit a single linear dimension greater than 10 μm; and wherein the polymer matrix material and particulate filler material are included in the composition in relative amounts effective to provide a dry composite film including greater than 15 volume percent filler material.

In a seventh embodiment, the present invention pertains to a casting composition comprising:

a carrier liquid;

a nonfibrillated non-fluoropolymer or fluoropolymer matrix material;

a particulate filler material wherein none of the particles of the particulate filler material exhibit a single linear dimension greater than 10 μm; and wherein the polymer matrix material and particulate filler material are included in the composition in relative amounts effective to provide a dry composite film including less than 15 volume percent filler material.

Upon removal of the carrier, and optionally other additives discussed herein, films are obtained. The films can be part of multilayer film constructs described herein.

In an eighth embodiment, the present invention pertains to a casting composition comprising:

a carrier liquid;

a nonfibrillated non-fluoropolymer matrix material;

a particulate filler material wherein none of the particles of the particulate filler material exhibit a single linear dimension greater than 10 μm; and wherein the polymer matrix material and particulate filler material are included in the composition in relative amounts effective to provide a dry composite film including greater than 15 volume percent filler material.

It should be understood that a third layer can be disposed upon the second layer to form a composite. The second layer is encapsulated by the first and third layers. The third layer can be a non-fluoropolymer or a fluoropolymer that is also from a castable solution.

Therefore, the present invention also provides casting compositions, methods to prepare cast multilayer films from these compositions, and multilayer films formed from these compositions. The multilayer films include a first outer layer, as described above, comprising an aqueous or solvent castable polymer, e.g., a fluoropolymer, a second inner layer, as described above, disposed upon the first layer, the second layer comprising an aqueous or solvent castable polymer, e.g., a fluoropolymer or mixtures thereof and a particulate filler material, as described above, and a third outer layer disposed upon the second layer comprising an aqueous or solvent castable polymer as described above e.g., a fluoropolymer or mixtures thereof.

Typically the first outer layer has a thickness of from about 0.01 mils to about 0.7 mils, more particularly from about 0.02 mils to about 0.4 mils and most particularly from about 0.05 mils to about 0.3 mils.

The second inner layer generally has a thickness of from about 0.1 mils to about 0.8 mils, more particularly from about 0.2 mils to about 0.4 mils and most particularly from about 0.3 mils to about 0.4 mils.

The third outer layer has, for example, has a thickness of from about 0.01 mils to about 0.7 mils, more particularly from about 0.02 mils to about 0.4 mils and most particularly from about 0.05 mils to about 0.3 mils.

Subsequent layers, e.g., fourth and fifth layers, can have a thickness of from about 0.01 mils to about 0.7 mils, more particularly from about 0.02 mils to about 0.4 mils and most particularly from about 0.05 mils to about 0.3 mils.

The phrase “multilayer” film is intended to include multiple layers of film(s) in contact with each other. At a minimum, two layers are present, although three layers are particularly desired. Additional layers can be included in the multilayer film such that the multilayer film can include 4, 5, 6 through 12 etc. layers.

The phrase “castable polymer” is intended to mean a fluoropolymer or non-fluoropolymer capable of being dispersed, dissolved, suspended, emulsified or otherwise distributed in a liquid carrier medium. The liquid carrier medium may be water, organic solvent, or any other liquid in which the polymer may be dispersed, dissolved, suspended, emulsified or otherwise distributed The liquid carrier medium may be a mixture of suitable liquids. Once distributed within the carrier medium, the polymer and medium is then capable of being deposited or cast upon a supporting material to form a film. The polymer(s) can be mixed with a first carrier liquid. The mixture may comprise a dispersion of polymeric particles in the first carrier liquid, an emulsion of liquid droplets of the polymer, or of a monomeric or oligomeric precursor of the polymer in the first carrier liquid or a solution of the polymer in the first carrier liquid.

The castable polymer(s) may also be a monomeric or oligomeric precursor of the polymer distributed within a carrier liquid. Most commonly castable compositions are emulsions or dispersions in aqueous media.

The choice of the first carrier liquid is based on the particular polymer and the form in which the material is to be introduced to the casting composition of the present invention. If a solution is desired, a solvent for the particular fluoropolymer is chosen as the carrier liquid. Suitable carriers include, for example, DMAC, NMP, cellosolves, or water and the like. If a dispersion is desired, then a suitable carrier is one in which the polymer is not soluble. An aqueous solution would be a suitable carrier liquid for a dispersion of polymer particles.

Most commonly castable compositions are emulsions or dispersions in aqueous media. Surfactants can be used to prepare a dispersion in an amount effective to modify the surface tension of the carrier liquid to enable the carrier liquid to wet the filler particles. Suitable surfactant compounds include ionic surfactants, amphoteric, cationic and nonionic surfactants.

In one exemplary embodiment, a mixture of a polymer, a carrier liquid and a dispersion of the filler particles in a second carrier liquid are combined to form a casting composition.

Fluoropolymers are generally selected as outer layers to provide chemical resistance, electrical insulation, weatherability and/or a barrier to moisture.

The phrase “fluoropolymer” is known in the art and is intended to include, for example polytetrafluoroethylene (PTFE), polyvinylidenefluoride (PVDF), polychlorotrifluoroethlylene (PCTFE), polyvinylfluoride (PVF), tetrafluoroethylene/hexafluoropropylene/ethylene copolymer (HTE), chlorotrifluoroethylene/vinylidenefluoride copolymer, chlorotrifluoroethylene/hexafluoropropylene, ethylene/chlorotrifluoro ethylene copolymers (ECTFE), ethylene/trifluoroethylene copolymers, ethylene/tetrafluoroethylene copolymers (ETFE), tetrafluoroethylene/propylene copolymers (TFE/P), tetrafluoroethylene/hexafluoropropylene copolymers (FEP), tetrafluoroethylene-perfluoro(alkyl vinyl ether) copolymers (PFAs e.g., tetrafluoroethylene-perfluoro(propyl vinyl ether), polyvinylidene difluoride, hexafluoropropylene/tetrafluoroethylene/vinylidene copolymers (i.e., THV) and mixtures thereof.

The fluoropolymer can be melt-processable, for example, as in the case of polyvinylidene difluoride; copolymers of vinylidene difluoride; copolymers of tetrafluoroethylene, hexafluoropropylene, and vinylidene difluoride; copolymers of tetrafluoroethylene and hexafluoropropylene; and other melt-processable fluoroplastics; or the fluoropolymer may not be melt-processable, for example, as in the case of polytetrafluoroethylene, copolymers of TFE and low levels of fluorinated vinyl ethers), and cured fluoroelastomers.

Examples of commercially available THV polymers include those marketed by Dyneon, LLC under the trade designations “DYNEON THV 2030G FLUOROTHERMOPLASTIC”, “DYNEON THV 220 FLUOROTHERMOPLASTIC”, “DYNEON THV 340C FLUOROTHERMOPLASTIC”, “DYNEON THV 415 FLUOROTHERMOPLASTIC”, “DYNEON THV 500A FLUOROTHERMOPLASTIC”, “DYNEON THV 610G FLUOROTHERMOPLASTIC”, or “DYNEON THV 810G FLUOROTHERMOPLASTIC”.

Examples of commercially available HTE polymers include those marketed, for example, under the trade designation “DYNEON FLUOROTHERMOPLASTIC HTE” (e.g., “DYNEON FLUOROTHERMOPLASTIC HTE X 1510” or “DYNEON FLUOROTHERMOPLASTIC HTE X 1705”) by Dyneon, LLC.

Examples of commercially available vinylidene difluoride-containing fluoropolymers include, for example, those fluoropolymers having the trade designations; “KYNAR” (e.g., “KYNAR 740”) as marketed by Atofina, Philadelphia, Pa.; “HYLAR” (e.g., “HYLAR 700”) as marketed by Ausimont USA, Morristown, N.J.; and “FLUOREL” (e.g., “FLUOREL FC-2178”) as marketed by Dyneon, LLC.

Examples of commercially available tetrafluoroethylene-perfluoro(alkyl vinyl ether) copolymers include those marketed for example, under the trade designation “Hyflon PFA”, or “Hyflon MFA” by Solvay Solexis; and “Teflon PFA” by E.I.diPont de Nemours & Company

Examples of commercially available vinyl fluoride fluoropolymers include, those homopolymers of vinyl fluoride marketed under the trade designation “TEDLAR” by E.I. du Pont de Nemours & Company, Wilmington, Del.

Examples of commercially available (TFE/P) polymers include, those marketed under the trade designations “AFLAS” (e.g., “AFLAS TFE ELASTOMER FA 100H”, “AFLAS TFE ELASTOMER FA 150C”, “AFLAS TFE ELASTOMER FA 150L”, or “AFLAS TFE ELASTOMER FA 150P”) as marketed by Dyneon, LLC, or “VITON” (e.g., “VITON VTR-7480” or “VITON VTR-7512”) as marketed by E.I. du Pont de Nemours & Company, Wilmington, Del.

Examples of commercially available ETFE polymers include, for example, those marketed under the trade designations “DYNEON FLUOROTHERMOPLASTIC ET 6210J”, “DYNEON FLUOROTHERMOPLASTIC ET 6235”, or “DYNEON FLUOROTHERMOPLASTIC ET 6240J” by Dyneon, LLC.

Examples of commercially available ECTFE polymers include those marketed under the trade designation Halar 350 and Halar 500 resin from Solvay Solexis Corp.

Alternatively, the polymer matrix material of the present invention can comprise a thermoplastic or thermosetting polymer other than a fluoropolymer. Suitable alternative polymeric matrix materials include polyolefins and copolymers thereof, such as polyethylenes, polypropylenes, polyethylene, polymethylpentene, and polybutadiene, epoxy resins, phenolic resins, cyanate esters, polyesters, polyamides, polycarbonates, polyimides, polyacrylics, polymethacrylics, thermoplastic olefins, ethylene vinyl alcohol (EVOH), ethylene vinyl acetate (EVA), ethylene methacrylate (EMA) thermoplastic urethanes, thermoplastic silicones, ionomers, ethyl butyl acrylate (EBA), polyvinyl butyral (PVB), ethylene propylene diene M-class rubbers (EPDM) or mixtures thereof.

The particulate filler material of the present invention can include any organic or inorganic particulate material. The terms “particulate” and “particles” as used herein are intended to include fibers and flakes. Suitable inorganic filler materials include, e.g. glass particles, ceramic particles, metallic particles, carbon particles and mineral particles. Specific examples of suitable particles and flakes include glass beads, glass microspheres, glass fibers, silica particles, carbon black, titanium dioxide particles, iron oxide particles, aluminum particles and barium titanate particles. Silica particles, particularly amorphous fused silica particles and silica particles made by a sol gel process, and glass particles, are applicable, e.g. dielectric layers of laminar electrical circuits, requiring a low dielectric constant.

The shape of the filler particles, the size of the filler particles and the size distribution of the filler particles can be important parameters with regard to characterizing the particle filled composite article of the present invention. For example platelet shaped pigments can give rise to light interfering and other optical effects. Such particles can include as mica coated iron or other metal oxide complexes (for example Taizhu TZ2013 violet from Wenzhou Pearlescent Pigments Co, Taizhu, China; and Xirallic T60-10 WNT crystal silver from Merck KGaA, Darmstadt, Germany)

In one embodiment of the present invention all particles of the particulate filler exhibit a diameter of less than about 10 microns (μm).

In an alternative preferred embodiment of the present invention, each of the filler particles exhibit no single linear dimension greater than about 10 μm.

In another embodiment, the particles of the particulate filler include some particles that are exhibit a single linear dimension greater than 10 μm. The percentage of the particles that exhibit a single linear dimension greater than 10 μm relative to particles that have a single linear dimension less than 10 μm can be from 0.01% to about 50%, from about 0.1% to about 20%, or from about 1% to about 10% of the total amount of particles. The linear dimension can be from about 11 μm to about 50 μm, from about 15 μm to about 20.

As stated previously, it has surprisingly been found that incorporation of particles that exhibit a single linear dimension greater than 10 μp can help provide unique properties to the ultimate film. These include increased tensile strength, greater opacity (than that without the larger particles), or decrease water vapor transmission.

Also, the particle does not need to be spherical. In one aspect, the particle can be oblong, also known as a “platelet” in the art.

In one aspect of the present invention each of the filler particles is substantially spherical.

In yet another aspect of the invention, the filler particles of the film are of a nonuniform size. The use of nonuniformly sized particles can provide an unexpected advantage in that light scattering and provide more uniform particle distribution. Generally, the particles are of an average particle size of between about 0.1 μm and about 20 μm, with approximately 80% of the particles having a narrow particle size range of between about 0.2 μm and about 5 μm.

The particulate filler material can be treated with a surface treatment to improve the moisture resistance, particle dispersion, matrix adhesion or IR reflectance, UV resistance of the film and/or improve the mechanical properties of the composite film of the present invention. For example, certain TiO₂ forms are passivated otherwise they are photocatalytic.

Suitable hydrophobic coatings useful to treat particles of the present invention may comprise any coating material that is thermally stable, exhibits a low surface energy, and improves the moisture resistance of the composite of the present invention. Suitable coating materials, include conventional silane coatings, titanate coatings and zirconate coatings.

The polymer matrix material of the present invention is mixed with a first carrier liquid. The mixture may comprise a dispersion of polymeric particles in the first carrier liquid, a dispersion, i.e. an emulsion, of liquid droplets of the polymer or of a monomeric or oligomeric precursor of the polymer in the first carrier liquid or a solution of the polymer in the first carrier liquid.

The choice of the first carrier liquid is based on the particular polymeric matrix material and the form in which the polymeric matrix material is to be introduced to the casting composition of the present invention. If a solution is desired, a solvent for the particular polymeric matrix material is chosen as the carrier liquid. Suitable carriers include, for example, DMAC, NMP, cellosolves, or water and the like. If a dispersion is desired, then a suitable carrier is one in which the matrix material is not soluble. An aqueous solution would be a suitable carrier liquid for a dispersion of fluoropolymer particles.

A dispersion of the particulate filler of the present invention can be in a suitable second carrier liquid in which the filler is not soluble.

Surfactants can be used prepare a dispersion in an amount effective to modify the surface tension of the second carrier liquid to enable the second carrier liquid to wet the filler particles. Suitable surfactant compounds include ionic surfactants, amphoteric, cationic and nonionic surfactants.

In one exemplary embodiment, a mixture of a polymeric matrix material and first carrier liquid and a dispersion of the filler particles in a second carrier liquid are combined to form a casting composition. Generally, the casting composition has between about 10 and about 90 weight percent solids (based on particles and polymeric matrix), from between about 20 to about 70 weight percent, or from between about 25 to about 50 weight percent.

The viscosity of the casting composition of the present invention can be adjusted by the addition of suitable viscosity modifiers. Such modifiers include polyacrylic acid compounds, vegetable gums and cellulose based compounds. Specific examples of suitable viscosity modifiers include polyacrylic acid, methyl cellulose, polyethyleneoxide, guar gum, locust bean gum, sodium carboxymethylcellulose, sodium alginate and gum tragacanth.

Generally, the casting composition has between about 10 and about 90 weight percent solids (based on particles and/or polymer), from between about 20 to about 70 weight percent, or from between about 25 to about 50 weight percent.

In general, the particulate filler material may be present within a castable polymer layer in a range of from about 0% by volume to about 60% by volume

In one aspect, the particulate filler is present from about 2% to about 50%, for example, from about 8% by volume to about 25% by volume based on the total volume of the multilayer film. In another aspect, the particulate filler is present from about 9% by volume to about 15% by volume based on the total volume of the multilayer film. It should be understood that subranges that fall within 0% to about 60% are included herein, including ranges that are fractional. That is from about 0.5% to about 5.5%, from about 0.6 to about 10.3%, etc. All ranges are included herein. The recitations of numerical ranges by endpoints include all numbers subsumed within that range (e.g., 1 to 5 includes 1, 1.5, 2, 2.75, 3, 3.80, 4, 5, etc.).

The viscosity of the casting composition of the present invention can be adjusted by the addition of suitable viscosity modifiers. Such modifiers include polyacrylic acid compounds, vegetable gums and cellulose based compounds. Specific examples of suitable viscosity modifiers include polyacrylic acid, methyl cellulose, polyethyleneoxide, guar gum, locust bean gum, sodium carboxymethylcellulose, sodium alginate and gum tragacanth.

To prepare a film, a layer of the composition is cast on a substrate by conventional methods, e.g. dip coating, reverse roll coating, knife-over-roll, knife-over-plate, and metering rod coating.

Suitable substrate materials include, e.g. metallic films, polymeric films or ceramic films. Specific examples of suitable substrates include stainless steel foil, polyimide films, or fluoropolymer films.

In an exemplary casting method, as detailed in U.S. Pat. No. 4,883,716, the contents of which are incorporated herein in their entirety, films are formed by casting onto a carrier belt having low thermal mass. The carrier belt is part of a casting apparatus. The carrier belt is dipped through a fluoropolymer matrix material/particular filler material dispersion in a dip pan at the base of a casting tower such that a coating of dispersion forms on the carrier belt. The coated carrier belt then passes through a metering zone in which metering bars remove excess dispersion from the coated carrier belt. After the metering zone, the coated carrier belt passes into a drying zone which is maintained at a temperature sufficient to remove the carrier liquid from the dispersion giving rise to a dried film. The carrier belt with the dried film then passes to a bake/fuse zone in which the temperature is sufficient to consolidate or fuse the fluoropolymer and particulates in the dispersion. Finally, the carrier belt passes through a cooling plenum from which it can be directed either to a subsequent dip pan to begin formation of a further layer of a subsequent film or to a stripping apparatus. The process can be repeated as many times as desired, generally providing up to 7 layers, e.g., 5 layers, 3 of which are fluoropolymer matrix/particular filler material layers and 2 are outer layers of one or more fluoropolymer(s).

In a further exemplary casting method, the coated film can remain on the carrier substrate such that a combined structure of substrate and cast film results. Examples of this can include fluoropolymer and a polyimide, an aluminum substrate or a polycarbonate. In a further example a separate substrate film may be introduced between the applied casting composition and the carrier belt, such that the castable fluoropolymer film is built up upon this substrate. In one example the substrate, a polyimide film, an aluminum sheet or a polycarbonate film may be supported on a carrier belt and the casting composition may be applied to the substrate. The casting composition can thus be applied to both surfaces of the substrate, such that the substrate is coated on top side and the bottom side. Suitable constructs include, for example a first castable fluoropolymer/aluminum/a second castable fluorpolymer which can be the same or different from the first castable fluoropolymer (e.g., PTFE/Al/PTFE), a first castable fluoropolymer/a polyimide/a second castable fluoropolymer which can be the same or different from the first castable fluoropolymer (e.g., FEP/a polyimide/FEP) and a first castable fluoropolymer/a polycarbonate/a second castable fluoropolymer which can be the same or different from the first castable fluoropolymer (e.g., PVDF/a polycarbonate/PVDF).

Other alternative substrate films may be employed depending on the process temperatures required for the fluoropolymer casting composition being deposited. Fluoropolymer compositions with lower fusing temperatures can use lower temperature substrates.

In one example, the carrier liquid and processing aids, such as a surfactant and/or viscosity modifiers, are removed from the cast layer by evaporation and/or by thermal decomposition, to provide a film of the polymeric matrix material and the particulate filler. In one aspect, the particulate filled polymeric matrix composite film of the present invention is prepared by heating the cast film to evaporate the carrier liquid.

The film of polymeric matrix material and particulate filler can be further heated to modify the physical properties of the film. This can include a post cure of the film.

In one aspect, the multilayer film has three layers. The first outer layer is a castable fluorpolymer, the second inner layer is a castable fluoropolymer with a particulate filler as described herein, and the third outer layer, is a castable fluoropolymer. In another aspect either or both of the first and third outer layers can include from about 0.01% by volume to about 12% by volume of a particulate filler and in particular from about 0.01% to about 6% by volume.

In another aspect, a fourth layer can be disposed on the first layer. The fourth layer is a castable fluoropolymer as described herein. In still another aspect, a fifth layer can be disposed on the third layer. The fifth layer is a castable fluoropolymer as described herein. Ideally, the fourth and fifth layers are selected from tetrafluoroethylene-perfluoro(alkyl vinyl ether) (PFA) copolymers or fluorinated ethylene propylene copolymers (FEP) or mixtures thereof. Additionally, the fourth and/or fifth layers can include mixtures of PTFE with a PFA or FEP.

The fourth and fifth layers can further include a particular filler as described herein. Either or both of the fourth and fifth outer layers can include from about 0.01% by volume to about 12% by volume of a particulate filler and in particular from about 0.01% to about 6% by volume.

In one aspect, the outer layers of the multilayer film can be fabricated from a melt bondable fluoropolymer. Suitable melt bondable materials include, for example, tetrafluoroethylene-perfluoro(alkyl vinyl ether) copolymers or fluorinated ethylene propylene copolymers (FEP) or mixtures thereof.

The process of the present invention provides films having thicknesses below about 2 mils, and even below about 1 mil, to be economically produced. Film thicknesses are set forth herein in terms of “mils”, wherein one mil is equal to 0.001 inch.

In yet another aspect the multilayer films of the invention have a total thickness of between about 0.6 mils to about 2 mils, more particularly from about 0.8 to about 1.5 mils.

In one embodiment, the present multilayer films have a dielectric break down strength (kV) greater than 3 kV measured by ASTM method D3755. In particular the dielectric break down strength is from greater than 3 kV to about 12 kV, from about 3 kV to about 7 kV and in particular from about 4 kV to about 6 kV.

Dielectric break down strength is measured according to ASTM D3755, Standard Test Method for Dielectric Breakdown Voltage and Dielectric Strength of Solid Electrical Insulating Materials Under Direct-Voltage Stress.

A test specimen of 5 inch×5 inch is held in air medium between two opposing cylinders 2 inches in diameter, 1 inch long with edges rounded to 0.25 inch radius. The specimen is electrically stressed by the application of an increasing direct voltage, at a uniform rate of 500 V/s, until internal breakdown occurs. Dielectric breakdown is generally accompanied by an increase in current in the test circuit that may activate a sensing element such as a circuit breaker or a fuse. The test voltage at breakdown is recorded.

In another embodiment, the multilayer film of have a solar reflectance on at least one side of the film of greater than 70% measured by ASTM method E424. In particular the solar reflectance on at least one side of the film is from great than 70% to about 99.9%, from about 75% to about 99% and in particular from about 80% to about 99%.

Solar Reflectance is measured according to ASTM E424, Standard Test Methods for Solar Energy Transmittance and Reflectance (Terristrial) of Sheet Materials. The specified procedure for ASTM E424 calls for data collection over the range of 350 to 2100 nm. Summation for data from 400-1100 nm is a commonly used variation of this procedure, and is the method used herein. (for the 5820 examples only)

An integrating sphere spectrophotometer is used to measure the spectral characteristics of the test specimen, 2 in.×2 in., over the spectrum region of interest. Smoked magnesium oxide is used as a standard for the completely reflecting and diffusing surface. Obtain spectral transmittance data relative to air, and spectral directional reflectance data relative to magnesium oxide. The solar transmittance, and reflectance, in percent, is calculated by integrating the spectral reflectance over the standard solar energy distribution. Solar transmittance is measured through the film while reflectance is generally measured relative to one side of the film. Opacity (%) is defined as 100%−Transmittance %.

In yet another embodiment, the multilayer films have a water vapor transmission rate that is less than about 20 g/m²/day measured by ASTM method F1249. In particular the water vapor transmission rate is less than about 16 g/m²/day, more particularly less than about 13 g/m²/day and most particularly less than about 8 g/m²/day.

Water vapor transmission rate is measured according to ASTM F1249, Water Vapor Transmission Rate Through Plastic Film and Sheeting Using a Modulated Infrared Sensor.

A test specimen of 4 in.×4 in. is tightly sealed using grease and an O-ring between a dry chamber and a wet chamber. Water vapor diffusing through the film mixes with the nitrogen gas in the dry chamber and is carried to a pressure-modulated infrared sensor. The sensor measures the fraction of infrared energy absorbed by the water vapor and produces an electrical signal, the amplitude of which is proportional to water vapor concentration. The amplitude of the electrical signal is compared to that of a calibration film of known water transmission rate, from which the rate of moisture transmitting through the test film is calculated. The testing is conducted at a constant temperature of humidity, for instance at 39° C. and 100% relative humidity. In still another embodiment, the multilayer films have a light opacity is greater than about 80% measured by ASTM method E424. In particular the light opacity is greater than about 80, more particularly greater than about 85 and most particularly greater than about 95.

In a particular embodiment the multilayer films described herein have a dielectric break down strength (kV) of greater than 3 kV measured by ASTM method D3755, a solar reflectance of greater than 70% measured by ASTM method E424, a water vapor transmission of less than 20 g/m²/day measured by ASTM method F1249 when the multilayer film has a thickness between about 0.7 mils and about 2.0 mils.

In another embodiment the multilayer films have two sided properties. For example they may have a white, highly reflective surface on one side, and a dark color surface on the other side. In another example they may have a white, highly reflective surface on one side, and a dark, non-reflective surface on the other side. In another embodiment, they may have a white, highly reflective surface on one side and a dark, reflective surface on the other side.

Color on either side of the film may be indicated by measuring color using a standard method called the CIE L*a*b* color model. In a particular embodiment of a two side color film, a black side and a white side may be distinguished. A low value of L* indicates a more black color with L*=0 being the most extreme black value. A high value of L* indicates a more white color with L*=100 being the maximum diffuse white measurement.

Fluoropolymers, used in particular for outer layers of the multilayer films described herein, are unique materials because they exhibit an outstanding range of properties such as high transparency, good dielectric strength, high purity, chemical inertness, low coefficient of friction, high thermal stability, excellent weathering, and UV resistance. Fluoropolymers are frequently used in applications calling for high performance in which oftentimes the combination of the above properties is required. However, due to their low surface energy, fluoropolymers are difficult to wet by most if not all non fluoropolymer materials either liquids or solids.

Subsequently, a common issue encountered with fluoropolymers is the difficult adhesion to non fluoropolymer surfaces. Again, this issue is particularly challenging for fluoropolymer composite laminates in which at least one layer is not a fluoropolymer.

The present invention provides novel multilayer films and methods to prepare the multilayer films by using suitable materials in conjunction with multiple deposition of layers followed by a further optional surface treatment. In general the multilayer films of the invention include an outer layer comprising a modified fluoropolymer and an inner layer(s) described herein having the polymeric matrix/particulate film(s).

The term “modified fluoropolymer” is intended to include fluoropolymers that are either bulk modified for surface modified, or both. Bulk fluoropolymer modification includes inclusion of polar functionality that is included or grafted into or onto the fluoropolymer backbone. This type of modified fluoropolymer material can be used in combination with an unmodified fluoropolymer layer and a non fluoropolymer layer or as the base fluoropolymer layer. For example, maleic anhydride modified ETFE is suitable to adhere Nylon to an untreated ETFE substrate.

Surface modification of fluoropolymers is another way to provide a modified fluoropolymer useful in the present invention. Generally, polar functionalities are attached to the fluoropolymer surface, rendering it easier to wet and provides opportunities for chemical bonding. There are several methods to functionalize a fluoropolymer surface including chemical etch, physical-mechanical etch, plasma etch, corona treatment, chemical vapor deposition, or any combination thereof. In an embodiment, the chemical etch includes sodium ammonia or sodium naphthalene. An exemplary physical-mechanical etch can include sandblasting and air abrasion with silica. In another embodiment, plasma etching includes reactive plasmas such as hydrogen, oxygen, acetylene, methane, and mixtures thereof with nitrogen, argon, and helium. Corona treatment can include the reactive hydrocarbon vapors such as ketones, e.g., acetone, alcohols, p-chlorostyrene, acrylonitrile, propylene diamine, anhydrous ammonia, styrene sulfonic acid, carbon tetrachloride, tetraethylene pentamine, cyclohexyl amine, tetra isopropyl titanate, decyl amine, tetrahydrofuran, diethylene triamine, tertiary butyl amine, ethylene diamine, toluene-2,4-diisocyanate, glycidyl methacrylate, triethylene tetramine, hexane, triethyl amine, methyl alcohol, vinyl acetate, methylisopropyl amine, vinyl butyl ether, methyl methacrylate, 2-vinyl pyrrolidone, methylvinylketone, xylene or mixtures thereof.

Some techniques use a combination of steps including one of these methods. For example, surface activation can be accomplished by plasma or corona in the presence of an excited gas species. For example surface activation can be accomplished by corona treatment in the presence of a solvent gas such as acetone.

Not to be limited by theory, the method has been found to provide strong interlayer adhesion between a modified fluoropolymer and a non fluoropolymer interface (or a second modified fluoropolymer). In one way, a fluoropolymer and a non fluoropolymer shape are each formed separately. Subsequently, the fluoropolymer shape is surface treated by the treatment process described in U.S. Pat. Nos. 3,030,290, 3,255,099, 3,274,089, 3,274,090, 3,274,091, 3,275,540, 3,284,331, 3,291,712, 3,296,011, 3,391,314, 3,397,132, 3,485,734, 3,507,763, 3,676,181, 4,549,921 and 6,726,979, the teachings of which are incorporated herein in their entirety for all purposes. Then, the resultant modified fluoropolymer and non fluoropolymer shapes are contacted together for example by heat lamination to form a multilayer film. Finally, the multilayer film can be submitted to a UV radiation with wavelengths in the UVA; UVB and/or UVC range.

In one aspect, the surface of the fluoropolymer substrate is treated with a corona discharge where the electrode area was flooded with acetone, tetrahydrofuran methylethyl ketone, ethyl acetate, isopropyl acetate or propyl acetate vapors.

Corona discharge is produced by capacitative exchange of a gaseous medium which is present between two spaced electrodes, at least one of which is insulated from the gaseous medium by a dielectric barrier. Corona discharge is somewhat limited in origin to alternating currents because of its capacitative nature. It is a high voltage, low current phenomenon with voltages being typically measured in kilovolts and currents being typically measured in milliamperes. Corona discharges may be maintained over wide ranges of pressure and frequency. Pressures of from 0.2 to 10 atmospheres generally define the limits of corona discharge operation and atmospheric pressures generally are preferred. Frequencies ranging from 20 Hz to 100 MHz can conveniently be used: in particular ranges are from 500 Hz, especially 3000 Hz to 10 MHz.

When dielectric barriers are employed to insulate each of two spaced electrodes from the gaseous medium, the corona discharge phenomenon is frequently termed an electrodeless discharge, whereas when a single dielectric barrier is employed to insulate only one of the electrodes from the gaseous medium, the resulting corona discharge is frequently termed a semi-corona discharge. The term “corona discharge” is used throughout this specification to denote both types of corona discharge, i.e. both electrodeless discharge and semi-corona discharge.

All details concerning the corona discharge treatment procedure are provided in a series of U.S. patents assigned to E. I. du Pont de Nemours and Company, USA, described in expired U.S. Pat. No. 3,676,181, and Saint-Gobain Performance Plastics Corporation U.S. Pat. No. 6,726,979, the teachings of which are incorporated herein in their entirety for all purposes. An example of the proposed technique may be found in U.S. Pat. No. 3,676,181 (Kowalski). The atmosphere for the enclosed treatment equipment is a 20% acetone (by volume) in nitrogen and is continuous. The outer layer of a constantly fed multilayer film or particulate filled film, for example, is subjected to between 0.15 and 2.5 Watt hrs per square foot of the film/sheet surface. The fluoropolymer can be treated on both sides of the film/shape to increase the adhesion. The material can then be placed on a non-siliconized release liner for storage. Materials that are C-treated last more than 1 year without significant loss of surface wettability, cementability and adhesion.

In another aspect, the surface of the fluoropolymer substrate is treated with a plasma. The phrase “plasma enhanced chemical vapor deposition” (PECVD) is known in the art and refers to a process that deposits thin films from a gas state (vapor) to a solid state on a substrate. There are some chemical reactions involved in the process, which occur after creation of a plasma of the reacting gases. The plasma is generally created by RF (AC) frequency or DC discharge between two electrodes where in between the substrate is placed and the space is filled with the reacting gases. A plasma is any gas in which a significant percentage of the atoms or molecules are ionized, resulting in reactive ions, electrons, radicals and UV radiation.

In another exemplary embodiment, at least one major surface of the fluoropolymer layer includes colloidal silica. The colloidal silica typically is present in a solution at an amount to provide adhesion between the first layer and the second layer. In an embodiment, the colloidal silica is present in a solution that does not adversely impact the adhesive properties of the colloidal silica. In an example, the solution may be aqueous. A commercially available colloidal silica solution is available as Ludox®. In an embodiment, a binding solution may be used in addition to the colloidal silica solution. Any known binding solution that is compatible with the colloidal silica is envisioned. For instance, a binding fluoropolymer, such as FEP or PFA may be used. Typically, the binding solution and colloidal silica are applied at a ratio of at least about 25/75 by weight, such as about 40/60 by weight, such as about 50/50 by weight, or even about 75/25 by weight.

The multilayer films of the invention can be used to protect, in particular, electronic components from moisture, weather, heat, radiation, physical damage and/or insulate the component. Examples of optoelectronic components include, but are not limited to, packaging for crystalline-silicon based photovoltaic modules, amorphous silicon, CIGS, DSC, OPV or CdTe based thin photovoltaic modules, OLEDS, LEDs, LCDs, printed circuit boards, flexible displays and printed wiring boards.

Any of the disclosed layers may contain common formulation additives including antioxidants, UV blockers, UV stabilizers, hindered amine stabilizers, curatives, crosslinkers, additional pigments, process aids and the like.

The following paragraphs enumerated consecutively from 1 through 48 provide for various aspects of the present invention. In one embodiment, in a first paragraph (1), the present invention provides a casting composition comprising: a carrier liquid; a nonfibrillated fluoropolymer matrix material; a particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein some of the particles of the particulate filler material exhibit a single linear dimension greater than 10 μm; and wherein the fluoropolymer matrix material and particulate filler material are included in the composition in relative amounts effective to provide a dry composite film including greater than 15 volume percent filler material.

2. A casting composition comprising: a carrier liquid; a nonfibrillated fluoropolymer matrix material; a particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein some of the particles of the particulate filler material exhibit a single linear dimension greater than 10 μm; and wherein the fluoropolymer matrix material and particulate filler material are included in the composition in relative amounts effective to provide a dry composite film including less than 15 volume percent filler material.

3. A casting composition comprising: a carrier liquid; a nonfibrillated fluoropolymer matrix material; a particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein none of the particles of the particulate filler material exhibit a single linear dimension greater than 10 μm; and wherein the fluoropolymer matrix material and particulate filler material are included in the composition in relative amounts effective to provide a dry composite film including less than 15 volume percent filler material.

4. A casting composition comprising: a carrier liquid; a nonfibrillated fluoropolymer matrix material; a particulate filler material selected calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein some of the particles of the particulate filler material exhibit a single linear dimension greater than 10 μm; and wherein the fluoropolymer matrix material and particulate filler material are included in the composition in relative amounts effective to provide a dry composite film including greater than 15 volume percent filler material.

5. A casting composition comprising: a carrier liquid; a nonfibrillated fluoropolymer matrix material; a particulate filler material selected from calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein some of the particles of the particulate filler material exhibit a single linear dimension greater than 10 μm; and wherein the fluoropolymer matrix material and particulate filler material are included in the composition in relative amounts effective to provide a dry composite film including less than 15 volume percent filler material.

6. A casting composition comprising: a carrier liquid; a nonfibrillated fluoropolymer matrix material; a particulate filler material selected from calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein none of the particles of the particulate filler material exhibit a single linear dimension greater than 10 μm; and wherein the fluoropolymer matrix material and particulate filler material are included in the composition in relative amounts effective to provide a dry composite film including greater than 15 volume percent filler material.

7. A casting composition comprising: a carrier liquid; a nonfibrillated fluoropolymer matrix material; a particulate filler material selected from calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein none of the particles of the particulate filler material exhibit a single linear dimension greater than 10 μm; and wherein the fluoropolymer matrix material and particulate filler material are included in the composition in relative amounts effective to provide a dry composite film including less than 15 volume percent filler material.

8. The casting composition of any of paragraphs 1 through 7, wherein the casting composition has a viscosity of between about 10 cp to about 100,000 cp at room temperature.

9. The casting composition of any of paragraphs 1 through 8, wherein: the casting composition comprises a codispersion of particles of the fluoropolymer and particles of the filler material in the carrier liquid.

10. The casting composition of any of paragraphs 1 through 8, wherein the carrier liquid comprises water.

11. The casting composition of any of paragraphs 1 through 10, wherein the fluoropolymer is selected polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, fluorinated ethylene/propylene copolymers or mixtures thereof.

12. The casting composition of any of paragraphs 1 through 11, wherein the filler particles compromise coated inorganic filler particles including an inorganic core and a coating layer surrounding the core.

13. The casting composition of paragraph 12, wherein the coating layer is a silane coating, a zirconate coating or a titanate coating.

14. The casting composition of any of paragraphs 3, 6 and 7, wherein the filler particles have a maximum equivalent spherical diameter of less than about 10 μm.

15. The casting composition of any of paragraphs 1 through 14, wherein each of the filler particles is spherical.

16. The casting composition of any of paragraphs 1 through 15, wherein all of the filler particles are of substantially the same particle size.

17. The casting composition of any of paragraphs 1 through 16, further comprising a surfactant for modifying the surface tension of the liquid so that the liquid wets the filler particles.

18. The casting composition of paragraph 17, wherein the surfactant is an ionic surfactant or a nonionic surfactant.

19. The casting composition of paragraph 17, wherein the surfactant is an amphoteric or cationic surfactant.

20. The casting composition of any of paragraphs 1 through 19 further comprising: a viscosity modifier added to adjust the viscosity of the casting composition to retard separation of the particulate filler from the composition to provide a stabilized, homogeneous casting composition.

21. A film comprising: a nonfibrillated fluoropolymer matrix material; a particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein some of the particles of the particulate filler material exhibit a single linear dimension greater than 10 μm; and wherein the fluoropolymer matrix material and particulate filler material are included in the composition in relative amounts effective to provide a composite film including greater than 15 volume percent filler material.

22. A film comprising: a nonfibrillated fluoropolymer matrix material; a particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein some of the particles of the particulate filler material exhibit a single linear dimension greater than 10 μm; and wherein the fluoropolymer matrix material and particulate filler material are included in the composition in relative amounts effective to provide a composite film including less than 15 volume percent filler material.

23. A film comprising: a nonfibrillated fluoropolymer matrix material; a particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein none of the particles of the particulate filler material exhibit a single linear dimension greater than 10 μm; and wherein the fluoropolymer matrix material and particulate filler material are included in the composition in relative amounts effective to provide a composite film including less than 15 volume percent filler material.

24. A film comprising: a nonfibrillated fluoropolymer matrix material; a particulate filler material selected from calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein some of the particles of the particulate filler material exhibit a single linear dimension greater than 10 μm; and wherein the fluoropolymer matrix material and particulate filler material are included in the composition in relative amounts effective to provide a composite film including greater than 15 volume percent filler material.

25. A film comprising: a nonfibrillated fluoropolymer matrix material; a particulate filler material selected from calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein some of the particles of the particulate filler material exhibit a single linear dimension greater than 10 μm; and wherein the fluoropolymer matrix material and particulate filler material are included in the composition in relative amounts effective to provide a composite film including less than 15 volume percent filler material.

26. A film comprising: a nonfibrillated fluoropolymer matrix material; a particulate filler material selected from calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein none of the particles of the particulate filler material exhibit a single linear dimension greater than 10 μm; and wherein the fluoropolymer matrix material and particulate filler material are included in the composition in relative amounts effective to provide a composite film including greater than 15 volume percent filler material.

27. A film comprising: a nonfibrillated fluoropolymer matrix material; a particulate filler material selected from calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein none of the particles of the particulate filler material exhibit a single linear dimension greater than 10 μm; and wherein the fluoropolymer matrix material and particulate filler material are included in the composition in relative amounts effective to provide a composite film including less than 15 volume percent filler material.

28. The film of any of paragraphs 21 through 27, wherein the fluoropolymer is selected from polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, fluorinated ethylene/propylene copolymers or mixtures thereof.

29. The film of any of paragraphs 21 through 28, wherein the filler particles compromise coated inorganic filler particles including an inorganic core and a coating layer surrounding the core.

30. The film of paragraph 29, wherein the coating layer is a silane coating, a zirconate coating or a titanate coating.

31. The film of any of paragraphs 23, 26 and 27, wherein the filler particles have a maximum equivalent spherical diameter of less than about 10 μm.

32. The film of any of paragraphs 21 through 31, wherein each of the filler particles is spherical.

33. The film of any of paragraphs 21 through 34, wherein all of the filler particles are of substantially the same particle size.

34. A multilayer film comprising: a first fluoropolymer film; a film of any of paragraphs 21 through 33 or a film comprising: a nonfibrillated fluoropolymer matrix material; and particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein none of the particles of the particulate filler material exhibit a single linear dimension greater than 10 μm; wherein the fluoropolymer matrix material and particulate filler material are included in the composition in relative amounts effective to provide a composite film including greater than 15 volume percent filler material; and a second fluoropolymer film.

35. A multilayer film comprising: a first film of any of paragraphs 21 through 33 or a film comprising: a nonfibrillated fluoropolymer matrix material; and particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein none of the particles of the particulate filler material exhibit a single linear dimension greater than 10 μm; wherein the fluoropolymer matrix material and particulate filler material are included in the composition in relative amounts effective to provide a composite film including greater than 15 volume percent filler material comprising a first percentage of filler material; and a second film of any of paragraphs 21 through 33 or a film comprising: a nonfibrillated fluoropolymer matrix material; and particulate filler material selected from silica particles, glass beads, glass microspheres, glass fibers, titanium dioxide particles, barium titanate particles or mixtures thereof, wherein none of the particles of the particulate filler material exhibit a single linear dimension greater than 10 μm; wherein the fluoropolymer matrix material and particulate filler material are included in the composition in relative amounts effective to provide a composite film including greater than 15 volume percent filler material comprising a second percentage of filler material.

36. The multilayer film of paragraph 35 comprising: one or more additional layers of a film of any of paragraphs 21 through 33 or a film comprising: a nonfibrillated fluoropolymer matrix material; and particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein none of the particles of the particulate filler material exhibit a single linear dimension greater than 10 μm; wherein the fluoropolymer matrix material and particulate filler material are included in the composition in relative amounts effective to provide a composite film including greater than 15 volume percent filler material, wherein the percentage of filler material can be the same or different.

37. The multilayer film of either of paragraphs 35 or 36 further comprising an outer fluoropolymer layer.

38. The multilayer film of any of paragraphs 34 through 36, wherein the fluoropolymer layer(s), if present, are each independently selected from PTFE FEP, or PFA.

39. A photovoltaic device comprising: a photovoltaic component and any of the films of paragraphs 22 through 38, wherein the photovoltaic component and film are packaged together.

40. A process to prepare a multilayer film comprising the steps: coating a casting composition onto a support, the casting composition comprising: a carrier; a nonfibrillated fluoropolymer matrix material; a particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein some of the particles of the particulate filler material exhibit a single linear dimension of about 10 μm; and wherein the fluoropolymer matrix material and particulate filler material are included in the composition in relative amounts effective to provide a composite film; contacting the composite film with a second casting composition, wherein the second casting composition comprises: a carrier; and polymeric material, thereby providing a multilayer film; and further contacting the multilayer film with a third casting composition, wherein the third casting composition comprises: a carrier; and a polymeric material, thereby providing a 3 layer multilayer film wherein the particle layer is in between the first and third layers.

41. The method of paragraph 40, further comprising a step of coating the composite film with one or more casting compositions comprising a carrier; a nonfibrillated fluoropolymer matrix material; a particulate filler material selected from silica particles, glass beads, glass microspheres, glass fibers, titanium dioxide particles, barium titanate particles, calcium carbonate, zinc oxide, mica, clay, talc, iron oxide, carbon black, zinc sulfide, barium sulfate, zinc sulfite, cobalt aluminate blue, sodium alumino sulphosilicate, magnesium hydroxide, antimony trioxide, organophosphates, brominated compounds or mixtures thereof, wherein some of the particles of the particulate filler material exhibit a single linear dimension of about 10 μm; and wherein the fluoropolymer matrix material and particulate filler material are included in the composition in relative amounts effective to provide a multilayer composite film layer.

42. The method of paragraph 41, further comprising contacting the multilayer composite film with a casting composition, wherein the casting composition comprises: a carrier; and polymeric material, thereby providing a multilayer film with a first outer layer.

43. The method of paragraph 42, further comprising further contacting the multilayer composite film with a casting composition, wherein the casting composition comprises: a carrier; and a polymeric material, thereby providing a multilayer film with a second outer layer wherein the multilayer composite particle layers are in between the two outer layers.

44. The method of any of paragraphs 40, 42 or 43, further comprising the step of: subjecting an outer layer to a charged particle process.

45. The method of paragraph 44, wherein the charged particle process is corona discharge or plasma treatment.

46. The method of paragraph 45, wherein the corona treatment is conducted in the presence of a solvent atmosphere.

47. The method of paragraph 46, wherein the solvent atmosphere is a ketone.

48. The photovoltaic device of paragraph 39, wherein the multilayer film is a backsheet to the photovoltaic component.

The following paragraphs enumerated consecutively from 1 through 68 provide for additional aspects of the present invention. In one embodiment, in a first paragraph (1), the present invention provides a multilayer film comprising a first layer comprising an aqueous or solvent castable fluoropolymer; a second layer disposed upon the first layer, the second layer comprising an aqueous or solvent castable fluoropolymer or mixtures thereof and a particulate filler material or mixtures thereof, wherein the particulate filler material is present in the castable fluoropolymer in a range of from about 10% by volume to about 45% by volume; and a third layer disposed upon the second layer comprising an aqueous or solvent castable fluoropolymer or mixtures.

2. The multilayer film of paragraph 1, wherein the particulate filler is present from about 8% by volume to about 25% by volume based on the total volume of the multilayer film.

3. The multilayer film of either of paragraphs 1 or 2, wherein the particulate filler is present from about 9% by volume to about 15% by volume based on the total volume of the multilayer film.

4. The multilayer film of any of paragraphs 1 through 3, wherein the first layer further comprises from about 0.0% by volume to about 12% by volume of a particulate filler.

5. The multilayer film of paragraph 4, wherein the particulate filler of the first layer is present from about 0.0% by volume to about 6% by volume.

6. The multilayer film of any of paragraphs 1 through 5, wherein the third layer further comprises from about 0.0% by volume to about 12% by volume of a particulate filler.

7. The multilayer film of paragraph 6, wherein the particulate filler of the third layer is present from about 0.0% by volume to about 6% by volume.

8. The multilayer film of any of paragraphs 4 through 7, wherein the particulate filler can be one or more fillers.

9. The multilayer film of any of paragraphs 1 through 8, further including a fourth layer comprising an aqueous or solvent castable fluoropolymer or mixtures thereof disposed upon the first layer.

10. The multilayer film of paragraph 9, further including a fifth layer comprising an aqueous or solvent castable fluoropolymer or mixtures thereof disposed upon the third layer.

11. The multilayer film of either of paragraphs 9 or 10, wherein the fourth and fifth layers are selected from tetrafluoroethylene-perfluoro(alkyl vinyl ether) copolymers (PFA) or fluorinated ethylene propylene copolymers (FEP) or mixtures thereof.

12. The multilayer film of any of paragraphs 9 through 11, wherein the fourth or fifth layer further comprises from about 0.0% by volume to about 12% by volume of a particulate filler.

13. The multilayer film of paragraph 12, wherein the particulate filler of the fourth or fifth layer is present from about 0.0% by volume to about 6% by volume.

14. The multilayer film of any of paragraphs 1 through 13, wherein the multilayer film has a thickness of between about 0.7 mil to about 2 mils.

15. The multilayer film of paragraph 14, wherein the multilayer film has a thickness of between about 0.8 mil and about 1.5 mils.

16. The multilayer film of any of paragraphs 1 through 15, wherein the dielectric break down strength (kV) is greater than 3 kV measured by ASTM method D3755.

17. The multilayer film of any of paragraphs 1 through 16, wherein the solar reflectance is greater than 70% measured by ASTM method E424.

18. The multilayer film of any of paragraphs 1 through 17, wherein the water vapor transmission rate is less than about 20 g/m²/day measured by ASTM method F1249.

19. The multilayer film of any of paragraphs 1 through 18, wherein the light opacity is greater than about 80% measured by ASTM method E424.

20. The multilayer film of any of paragraphs 1 through 19, wherein the dielectric break down strength (kV) is greater than 3 kV measured by ASTM method D3755, the solar reflectance is greater than 70% measured by ASTM method E424, the water vapor transmission is less than 20 g/m²/day measured by ASTM method F1249 when the multilayer film has a thickness between about 0.7 mils and about 2.0 mils.

21. A series of casting compositions to prepare a multilayer film comprising a first castable composition comprising a first carrier liquid and a first castable fluoropolymer; a second castable composition comprising a second carrier liquid, a second castable fluoropolymer and a particulate filler material, wherein the particulate filler material is present in the second castable fluoropolymer in a range of from about 20% by volume to about 45% by volume; and a third castable composition comprising a third carrier liquid and third castable fluoropolymer.

22. The series of casting compositions of paragraph 21, wherein the first, second and third carrier liquids are aqueous, a solvent or mixtures thereof.

23. The series of casting compositions of either paragraphs 21 or 22, wherein the particulate filler is present from about 8% by volume to about 25% by volume based on the total volume of the multilayer film.

24. The series of casting compositions of any of paragraphs 21 through 23, wherein the particulate filler is present from about 9% by volume to about 15% by volume based on the total volume of the multilayer film.

25. The series of casting compositions of any of paragraphs 21 through 24, wherein the first castable composition further comprises from about 0.0% by volume to about 12% by volume of a particulate filler.

26. The series of casting compositions of paragraph 25, wherein the particulate filler of the first layer is present from about 0.0% by volume to about 6% by volume.

27. The series of casting compositions of any of paragraphs 21 through 26, wherein the third castable composition further comprises from about 0.0% by volume to about 12% by volume of a particulate filler.

28. The series of casting compositions of paragraph 27, wherein the particulate filler of the third layer is present from about 0.0% by volume to about 6% by volume.

29. The series of casting compositions of any of paragraphs 25 through 28, wherein the particulate filler can be one or more fillers.

30. The series of casting compositions of any of paragraphs 21 through 29, further including a fourth castable composition comprising a fourth carrier liquid and a castable fluoropolymer to be disposed upon the first castable composition.

31. The series of casting compositions of any of paragraph 30, further including a fifth castable composition comprising a fifth carrier liquid and a castable fluoropolymer to be disposed upon the third castable composition.

32. The series of casting compositions of any of paragraphs 30 or 31, wherein the fourth and fifth carrier liquids are aqueous, a solvent or mixtures thereof.

33. The series of casting compositions of any of paragraphs 30 through 32, wherein the fourth and fifth castable fluoropolymers are selected from tetrafluoroethylene-perfluoro(alkyl vinyl ether) (PFA) copolymers or fluorinated ethylene propylene copolymers (FEP) or mixtures thereof.

34. The series of casting compositions of any of paragraphs 30 through 33, wherein the fourth or fifth layer further comprises from about 0.0% by volume to about 12% by volume of a particulate filler.

35. The series of casting compositions of paragraph 34, wherein the particulate filler of the third layer is present from about 0.0% by volume to about 6% by volume.

36. The series of casting compositions of any of paragraphs 21 through 35, wherein the multilayer film has a thickness of between about 0.6 mil to about 2 mils when the carrier is removed.

37. The series of casting compositions of paragraph 36, wherein the multilayer film has a thickness of between about 0.8 mil and about 1.5 mils.

38. The series of casting compositions of any of paragraphs 21 through 37, wherein the dielectric break down strength (kV) of the multilayer film is greater than 3 kV measured by ASTM method D3755.

39. The series of casting compositions of any of paragraphs 21 through 38, wherein the solar reflectance of the multilayer film is greater than 70% measured by ASTM method E424.

40. The series of casting compositions of any of paragraphs 21 through 39, wherein the water vapor transmission rate of the multilayer film is less than about 20 g/m²/day measured by ASTM method F1249.

41. The series of casting compositions of any of paragraphs 21 through 40, wherein the light opacity of the multilayer film is greater than about 80% measured by ASTM method E424.

42. The series of casting compositions of any of paragraphs 21 through 41, wherein the dielectric break down strength (kV) of the multilayer film is greater than 3 kV measured by ASTM method D3755, the solar reflectance is greater than 70% measured by ASTM method E424, the water vapor transmission is less than 20 g/m²/day measured by ASTM method F1249 when the multilayer film has a thickness between about 0.7 mils and about 2.0 mils.

43. A process to prepare a multilayer film comprising the steps coating a first casting composition onto a support to form a first layer, the casting composition comprising a first carrier liquid and a first castable fluoropolymer; contacting the first layer with a second casting composition to form a second layer, wherein the second casting composition comprises a second carrier liquid, a second castable fluoropolymer and a particulate filler material, wherein the particulate filler material is present in the second castable fluoropolymer in a range of from about 20% by volume to about 45% by volume; and contacting the second layer with a third casting composition to form a third layer, such that the second layer is encapsulated by the first and third layers, wherein the third casting composition comprises a third carrier liquid and a third castable fluoropolymer.

44. The process of paragraph 43, wherein the first, second and third carrier liquids are aqueous, a solvent or mixtures thereof.

45. The process of either paragraphs 43 or 44, wherein the particulate filler is present from about 8% by volume to about 25% by volume based on the total volume of the multilayer film.

46. The process of any of paragraphs 43 through 45, wherein the particulate filler is present from about 9% by volume to about 15% by volume based on the total volume of the multilayer film.

47. The process of any of paragraphs 43 through 46, wherein the first castable composition further comprises from about 0.0% by volume to about 12% by volume of a particulate filler.

48. The process of paragraph 47, wherein the particulate filler of the first layer is present from about 0.0% by volume to about 6% by volume.

49. The process of any of paragraphs 43 through 48, wherein the third castable composition further comprises from about 0.0% by volume to about 12% by volume of a particulate filler.

50. The process of paragraph 49, wherein the particulate filler of the third layer is present from about 0.0% by volume to about 6% by volume.

51. The process of any of paragraphs 47 through 50, wherein the particulate wherein the particulate filler can be one or more fillers.

52. The process of any of paragraphs 43 through 51, further including a fourth castable composition comprising a fourth carrier liquid and a castable fluoropolymer to be disposed upon the first castable composition.

53. The process of paragraph 52, further including a fifth castable composition comprising a fifth carrier liquid and a castable fluoropolymer to be disposed upon the third castable composition.

54. The process of any of paragraphs 52 or 53, wherein the fourth and fifth carrier liquids are aqueous, a solvent or mixtures thereof.

55. The process of any of paragraphs 52 through 54, wherein the fourth and fifth castable fluoropolymers are selected from tetrafluoroethylene-perfluoro(alkyl vinyl ether) (PFA) copolymers or fluorinated ethylene propylene copolymers (FEP) or mixtures thereof.

56. The process of any of paragraphs 52 through 55, wherein the fourth or fifth layer further comprises from about 0.0% by volume to about 12% by volume of a particulate filler.

57. The process of paragraph 56, wherein the particulate filler of the third layer is present from about 0.0% by volume to about 6% by volume.

58. The process of any of paragraphs 43 through 57, wherein the multilayer film has a thickness of between about 0.7 mil to about 2 mils when the carrier is removed.

59. The process of paragraph 58, wherein the multilayer film has a thickness of between about 0.8 mil and about 1.5 mils.

60. The process of any of paragraphs 43 through 59, wherein the dielectric break down strength (kV) of the multilayer film is greater than 3 kV measured by ASTM method D3755.

61. The process of any of paragraphs 43 through 60, wherein the solar reflectance of the multilayer film is greater than 70% measured by ASTM method E424.

62. The process of any of paragraphs 43 through 61, wherein the water vapor transmission rate of the multilayer film is less than about 20 g/m²/day measured by ASTM method F1249.

63. The process of any of paragraphs 43 through 62, wherein the light opacity of the multilayer film is greater than about 80% measured by ASTM method E424.

64. The process of any of paragraphs 43 through 63, wherein the dielectric break down strength (kV) of the multilayer film is greater than 3 kV measured by ASTM method D3755, the solar reflectance is greater than 70% measured by ASTM method E424, the water vapor transmission is less than 20 g/m²/day measured by ASTM method F1249 when the multilayer film has a thickness between about 0.8 mils and about 1.1 mils.

65. A photovoltaic comprising a photovoltaic component and any of the multilayer films of any paragraphs 1 through 64, wherein the photovoltaic component and multilayer film are packaged together.

66. The optoelectronic device of paragraph 65 wherein the optoelectronic component comprises a photovoltaic component.

67. The photovoltaic device of paragraph 66 wherein the multilayer film is disposed upon an encapsulation film.

68. The photovoltaic device of paragraph 67 wherein the encapsulation film is selected from ethylene vinyl acetate, ethylene methyl acrylate, thermoplastic urethane, polyvinylbutyral, silicone, polyolefin polymers, polyolefin copolymers, or ionomers.

The following paragraphs enumerated consecutively from 1 through 68 provide for still additional aspects of the present invention. In one embodiment, in a first paragraph (1), a casting composition comprising: a carrier liquid; a nonfibrillated polymer matrix material; a particulate filler material wherein some of the particles of the particulate filler material exhibit a single linear dimension greater than 10 μm; and wherein the polymer matrix material and particulate filler material are included in the composition in relative amounts effective to provide a dry composite film including greater than 15 volume percent filler material.

2. A casting composition comprising: a carrier liquid; a nonfibrillated polymer matrix material; a particulate filler material wherein some of the particles of the particulate filler material exhibit a single linear dimension greater than 10 μm; and wherein the polymer matrix material and particulate filler material are included in the composition in relative amounts effective to provide a dry composite film including less than 15 volume percent filler material.

3. A casting composition comprising: a carrier liquid; a nonfibrillated polymer matrix material; a particulate filler material wherein none of the particles of the particulate filler material exhibit a single linear dimension greater than 10 μm; and wherein the polymer matrix material and particulate filler material are included in the composition in relative amounts effective to provide a dry composite film including less than 15 volume percent filler material.

4. A casting composition comprising: a carrier liquid; a nonfibrillated polymer matrix material; a particulate filler material wherein none of the particles of the particulate filler material exhibit a single linear dimension greater than 10 μm; and wherein the polymer matrix material and particulate filler material are included in the composition in relative amounts effective to provide a dry composite film including greater than 15 volume percent filler material.

5. A casting composition comprising: a carrier liquid; a nonfibrillated non-fluoropolymer matrix material; a particulate filler material wherein none of the particles of the particulate filler material exhibit a single linear dimension greater than 10 μm; and wherein the non-fluoropolymer matrix material and particulate filler material are included in the composition in relative amounts effective to provide a dry composite film including greater than 15 volume percent filler material.

6. The casting composition of any of paragraphs 1 through 5, wherein the casting composition comprises a codispersion of particles of a fluoropolymer and particles of the filler material in the carrier liquid.

7. The casting composition of any of paragraphs 1 through 6, wherein the carrier liquid comprises water.

8. The casting composition of any of paragraphs 1 through 7, wherein the polymer is polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, tetrafluoroethylene/hexafluoropropylene copolymers, tetrafluoroethylene-perfluoro(alkyl vinyl ether) copolymers or mixtures thereof.

9. The casting composition of any of paragraphs 1 through 8, wherein the filler particles compromise coated inorganic filler particles including an inorganic core and a coating layer surrounding the core.

10. The casting composition of paragraph 9, wherein the coating layer is a silane coating, a zirconate coating or a titanate coating.

11. The casting composition of any of paragraphs 1 through 10, wherein all of the filler particles are of substantially the same particle size.

12. The casting composition of any of paragraphs 1 through 11, further comprising a surfactant for modifying the surface tension of the liquid so that the liquid wets the filler particles.

13. The casting composition of paragraph 12, wherein the surfactant is an ionic surfactant or a nonionic surfactant.

14. The casting composition of paragraph 12, wherein the surfactant is an amphoteric or cationic surfactant.

15. The casting composition of any of paragraphs 1 through 14 further comprising: a viscosity modifier added to adjust the viscosity of the casting composition to retard separation of the particulate filler from the composition to provide a stabilized, homogeneous casting composition.

16. A film comprising: a nonfibrillated polymer matrix material; a particulate filler material selected wherein some of the particles of the particulate filler material exhibit a single linear dimension greater than 10 μm; and wherein the polymer matrix material and particulate filler material are included in the composition in relative amounts effective to provide a composite film including greater than 15 volume percent filler material.

17. A film comprising: a nonfibrillated polymer matrix material; a particulate filler material wherein some of the particles of the particulate filler material exhibit a single linear dimension greater than 10 μm; and wherein the polymer matrix material and particulate filler material are included in the composition in relative amounts effective to provide a composite film including less than 15 volume percent filler material.

18. A film comprising: a nonfibrillated polymer matrix material; a particulate filler material wherein none of the particles of the particulate filler material exhibit a single linear dimension greater than 10 μm; and wherein the polymer matrix material and particulate filler material are included in the composition in relative amounts effective to provide a composite film including less than 15 volume percent filler material.

19. A film comprising: a nonfibrillated polymer matrix material; a particulate filler material wherein none of the particles of the particulate filler material exhibit a single linear dimension greater than 10 μm; and wherein the polymer matrix material and particulate filler material are included in the composition in relative amounts effective to provide a composite film including greater than 15 volume percent filler material.

20. A film comprising: a nonfibrillated non-fluoropolymer matrix material; a particulate filler material wherein none of the particles of the particulate filler material exhibit a single linear dimension greater than 10 μm; and wherein the non-fluoropolymer matrix material and particulate filler material are included in the composition in relative amounts effective to provide a dry composite film including greater than 15 volume percent filler material.

21. The film of any of paragraphs 16 through 20, wherein the polymer is polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, tetrafluoroethylene/hexafluoropropylene copolymers, tetrafluoroethylene-perfluoro(alkyl vinyl ether) copolymers or mixtures thereof.

22. The film of any of paragraphs 16 through 21, wherein the filler particles compromise coated inorganic filler particles including an inorganic core and a coating layer surrounding the core.

23. The film of paragraph 23, wherein the coating layer is a silane coating, a zirconate coating or a titanate coating.

24. The film of any of paragraphs 16 through 23, wherein each of the filler particles is spherical.

25. A multilayer film comprising: a first fluoropolymer film; a second film of any of paragraphs 16 through 24 disposed on the first fluoropolymer film; and a third fluoropolymer film disposed on the second film.

26. A multilayer film comprising: a first film of any of paragraphs 16 through 24; and a second film of any of paragraphs 16 through 24.

27. The multilayer film of paragraph 26 further comprising: one or more additional layers of a film of any of paragraphs 16 through 23 or a film.

28. The multilayer film of either of paragraphs 26 or 27 further comprising an outer fluoropolymer layer.

29. The multilayer film of any of paragraphs 26 through 28, wherein the fluoropolymer layer(s), if present, are each independently selected from PTFE, ETFE, FEP, or PFA.

30. A photovoltaic device comprising: a photovoltaic component and any of the films of paragraphs 16 through 29, wherein the photovoltaic component and film are packaged together.

31. A process to prepare a multilayer film comprising the steps: coating a casting composition onto a support, the casting composition comprising: a carrier; a nonfibrillated polymer matrix material; a particulate filler material wherein some of the particles of the particulate filler material exhibit a single linear dimension of about 10 μm; and wherein the polymer matrix material and particulate filler material are included in the composition in relative amounts effective to provide a composite film; contacting the composite film with a second casting composition, wherein the second casting composition comprises: a carrier; and a polymeric matrix material, thereby providing a multilayer film; and further contacting the multilayer film with a third casting composition, wherein the third casting composition comprises: a carrier; and a polymeric matrix material, thereby providing a 3 layer multilayer film wherein the particle layer is in between the first and third layers.

32. The process of paragraph 31, further comprising a step of coating the composite film with one or more casting compositions comprising a carrier; a nonfibrillated polymer matrix material; a particulate filler material wherein some of the particles of the particulate filler material exhibit a single linear dimension of about 10 μm; and wherein the polymer matrix material and particulate filler material are included in the composition in relative amounts effective to provide a multilayer composite film layer.

33. The process of paragraph 32, further comprising contacting the multilayer composite film with a casting composition, wherein the casting composition comprises: a carrier; and a polymeric material, thereby providing a multilayer film with a first outer layer.

34. The process of paragraph 33, further comprising further contacting the multilayer composite film with a casting composition, wherein the casting composition comprises: a carrier; and a polymeric material, thereby providing a multilayer film with a second outer layer wherein the multilayer composite particle layers are in between the two outer layers.

35 The process of any of paragraphs 31 through 34, further comprising the step of subjecting an outer layer to a charged particle process.

36. The method of paragraph 35, wherein the charged particle process is corona discharge or plasma treatment.

37. The method of paragraph 36, wherein the corona treatment is conducted in the presence of a solvent atmosphere.

38. The method of paragraph 37, wherein the solvent atmosphere is a ketone.

39. The photovoltaic device of paragraph 38, wherein the multilayer film is a backsheet to the photovoltaic component.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### EXAMPLES

### Preparation of Cast Fluoropolymer Films

General Procedure for Casting of Films

(a) An aqueous dispersion is prepared with organic or inorganic fillers, such as a white pigment (TiO₂, ZnO or others described herein).

(b) An aqueous dispersion is prepared that includes a film forming polymeric material chosen from any of those described throughout the specification, and in particular, a fluoropolymer. This dispersion may contain the aqueous dispersion described in step (a).

(c) A carrier belt can then be dipped through the dispersion described in step (b) such that a coating of the dispersion is formed on the carrier belt.

(d) The coated carrier belt is passed through a metering zone to remove excess dispersion.

(e) The metered coated carrier is dried to remove the water from the dispersion.

(f) The dried coated carrier is then heated to a temperature sufficient to consolidate the dispersion, wherein the carrier belt is formed from a material of low thermal mass having chemical and dimensional stability at the consolidation temperature of the dispersion and a work of adhesion between the carrier belt and the dispersion that does not exceed the yield strength of the consolidated fluoropolymeric film.

(g) Step (c) to Step (f) can be repeated if necessary for casting multiple-layer films. At least one of the dispersion coatings will contain the dispersion described in steps (a) or (b).

(h) Optionally, the film is stripped off the carrier (such as a polyimide).

(i) Optionally, the multilayer film can be C-treated on one side or both sides or otherwise, so that the surface can be treated to be bondable.

Dispersions:

PTFE Dispersion with 22 Volume % TiO₂

Mix 3,384 g of PTFE dispersion (Daikin, 59% solids), 1,772 g of TiO₂ slurry (DuPont R-900 TiO₂, 60% solids,) and 1,400 deionized water for 30 minutes. Add 32 g of modified fluoroalkylsurfactant (Ciba, 60% solids) to the mixture and mix for additional 10 minutes. Filter the solution through a 10 micron screen.

PTFE Dispersion with 14.8 vol % TiO₂

Mix 3,000 g of PTFE dispersion (Daikin, 59% solids), 990 g of TiO₂ slurry (DuPont R-900 TiO₂, 60% solids,) and 800 deionized water for 30 minutes. Add 24 g of modified surfactant (Ciba, 60% solids) to the mixture and mix for additional 10 minutes. Filter the solution through a 10 micron screen.

PTFE Dispersion with 12% TiO₂

Mix 1,532 g of PTFE dispersion (Daikin, 59% solids), 400 g of TiO₂ slurry (DuPont R-900 TiO₂, 60% solids,) and 550 deionized water for 30 minutes. Add 10 g of modified surfactant (Ciba, 60% solids) to the mixture and mix for additional 10 minutes. Filter the solution through a 10 micron screen.

PTFE Dispersion with 38 Volume % TiO₂

Mix 3,000 g of PTFE dispersion (Daikin, 60% solids), 3,440 g of TiO₂ slurry (DuPont R-900 TiO₂, 60% solids,) and 3,500 g deionized water for 30 minutes. Add 50 g of modified fluoroalkylsurfactant (Ciba, 60% solids) to the mixture and mix for additional 10 minutes. Filter the solution through a 10 micron screen.

PTFE Dispersion with 4 Volume % TiO₂

Mix 7,659 g of PTFE dispersion (Daikin, 60% solids), 666 g of TiO₂ slurry (DuPont R-900 TiO₂, 60% solids,) and 1,625 g deionized water for 30 minutes. Add 50 g of modified fluoroalkylsurfactant (Ciba, 60% solids) to the mixture and mix for additional 10 minutes. Filter the solution through a 10 micron screen.

PTFE Dispersion with 41 Volume % TiO₂

Mix 550 g of PTFE dispersion (Daikin, 60% solids), 826 g of TiO₂ slurry (DuPont R-900 TiO₂, 60% solids,) and 600 g deionized water for 30 minutes. Add 10 g of modified fluoroalkylsurfactant (Ciba, 60% solids) and 13.2 g on an acrylic copolymer (Rohm and Haas, 100% solids) to the mixture and mix for additional 10 minutes. Filter the solution through a 10 micron screen.

PTFE Dispersion with 28 Volume % TiO₂

Mix 3,970 g of PTFE dispersion (Daikin, 60% solids), 2,870 g of TiO₂ slurry (DuPont R-900 TiO₂, 60% solids,) and 3,110 g deionized water for 30 minutes. Add 50 g of modified fluoroalkylsurfactant (Ciba, 60% solids) to the mixture. Filter the solution through a 10 micron screen.

PTFE Dispersion with 3% Volume TiO₂

Mix 728 g of PTFE dispersion (Daikin, 60% solids), 105 g of TiO₂ slurry (DuPont R-900 TiO₂, 60% solids,) and 172 g deionized water for 30 minutes. Add 5 g of modified fluoroalkylsurfactant (Ciba, 60% solids) to the mixture. Filter the solution through a 10 micron screen.

PTFE Dispersion with 2 Vol % Carbon Black

Mix 816 g of PTFE dispersion (Daikin, 60% solids), 33 g of Carbon Black slurry (TOKAI Aqua black, 30% solids,) and 143 g deionized water for 30 minutes. Add 5 g of modified fluoroalkylsurfactant (Ciba, 60% solids) and 3 gram of an acrylic copolymer (Rohm and Haas, 100% solids) to the mixture. Filter the solution through a 10 micron screen

Clear PTFE Dispersion Without Filler

Mix 796 g of PTFE dispersion (Daikin, 59% solids) and 157 deionized water for 30 minutes. Filter the solution through a 10 micron screen.

Clear PFA Dispersion Without Filler

Mix 1,480 g of PFA dispersion (DuPont, 58-62% solids) and 2520 g deionized water for 30 minutes. Add 10 g of modified non-ionic surfactant (DuPont, 50% solids) to the mixture and mix for additional 10 minutes. Filter the solution through a 10 micron screen.

Clear FEP Dispersion Without Filler

Mix 1,000 g of FEP dispersion (DuPont, 41% solids) and 450 g deionized water for 30 minutes. Add 2.25 g of modified non-ionic surfactant (DuPont, 50% solids) to the mixture and mix for additional 10 minutes. Filter the solution through a 10 micron screen.

The following films were prepared following the general procedure:

### Example 1

Using the general procedure and process described above, a four layer film was prepared with the following construction:

PTFE with 22.0 vol % TiO₂
PTFE with 22.0 vol % TiO₂
PTFE with 22.0 vol % TiO₂
FEP (no filler)

Total film thickness: 1.1 mil

### Example 2

Using the general procedure and process described above, a five layer film as prepared with the following construction:

PTFE (no filler)
PTFE with 14.8 vol % TiO₂
PTFE with 14.8 vol % TiO₂
PTFE with 14.8 vol % TiO₂
FEP (no filler)

Total film thickness: 1.1 mil

### Example 3

PTFE with 12 vol % TiO₂
PTFE with 12 vol % TiO₂
PTFE with 12 vol % TiO₂
FEP (no filler)

Total film thickness 1.1 mil

The following properties were measured:

| | | | Dielectric |
|---|---|---|---|
| | Transmission | Opacity | Breakdown |
| Example | (%) | (%) | strength (kV) |
| 1 | 7.4 | 92.6% | 1.65 |
| 2 | 9.8 | 90.2 | 3.91 |
| 3 | 9.5 | 90.5 | 4.04 |
| Tedlar | 12.9 | 87.1 | 3.00 |
| (PV2111) | | | |

Tedlar PV2111 is a commercial film sold by DuPont and is used in PV backsheet lamination. Film thickness is 1.0 mil.

A value of Dielectric Breakdown strength >=3.00 kV is generally considered acceptable for a 1 mil PV backsheet film.

Test Methods:

Dielectric breakdown strength measurements were generally measured according to ASTM D149 using Beckman Dielectric Tester QC101A Films were placed between circular electrodes having a diameter of 0.25 inch. A ramped DC voltage was then applied at a constant ramp rate (typically 500 V/s) starting from zero volts. The voltage at which a burn through of the film thickness is observed was reported as the dielectric breakdown voltage.

Light transmission was measured according to ASTM E424 using a Gretag Macbeth Color-Eye® 7000A Spectrophotometer. The wavelength scan range was 400 nm-750 nm. Background correction scan was performed leaving the transmittance port empty and reflectance standard in the reflectance port. Films were then loaded in the transmittance port of the accessory and % total transmittance (diffuse+regular transmittance) was determined. Opacity %=100%−transmission %.

### Example 4

Using the general procedure and process described above, a five layer film was prepared with the following construction:

| Composition | Thickness (mils) |
|---|---|
| PFA - no filler | 0.10 |
| PTFE - no filler | 0.35 |
| PTFE with 38 Vol % TiO₂ | 0.35 |
| PTFE with 4 Vol % TiO₂ | 0.20 |
| FEP - no filler | 0.10 |
| Total (9.6 Vol % TiO₂) | 1.10 |

### Example 5

Using the general procedure and process described above, a five layer film was prepared with the following construction:

| Composition | Thickness (mils) |
|---|---|
| PFA - no filler | 0.03 |
| PTFE - no filler | 0.35 |
| PTFE with 41 Vol % TiO₂ | 0.35 |
| PTFE no filler | 0.25 |
| FEP - no filler | 0.03 |
| Total (11.6 Vol % TiO₂) | 1.01 |

### Example 6

Using the general procedure and process described above, a three layer film was prepared with the following construction:

| Composition | Thickness (mils) |
|---|---|
| PTFE with 22 Vol % TiO₂ | 0.35 |
| PTFE with 22 Vol % TiO₂ | 0.35 |
| FEP - no filler | 0.20 |
| Total (16.4 Vol % TiO₂) | 0.90 |

### Measured Properties

| | Dielectric | | | |
|---|---|---|---|---|
| | Strength | Opacity | WVTR | Reflectance |
| | (kV) | (%) | (g/m 2/day) | (%) |
| Example 4 | 6.1 | 81.91 | 7.72 | 77.91 |
| Example 5 | 4.9 | 83.04 | 10.5 | 78.53 |
| Example 6 | 1.6 | 85.47 | 127 | 81.28 |

### Example 7

Using the general procedure and process described above, a five layer film was prepared with the following construction:

| Composition | Thickness (mils) |
|---|---|
| PFA-no filler | 0.05 |
| PTFE - no filler | 0.25 |
| PTFE with 28 Vol % TiO₂ | 0.40 |
| PTFE with 3 Vol % TiO₂ | 0.25 |
| FEP - no filler | 0.05 |
| Total (10.5 Vol % TiO₂) | 1.0 |

| | Dielectric | | | |
|---|---|---|---|---|
| | Strength | Opacity | WVTR | Reflectance |
| | (kV) | (%) | (g/m2/day) | (%) |
| Example | 3.98 | 80.79 | 12.7 | 76.39 |
| 7 | | | | |

### Example 8

Using the general procedure and process described above, a five layer film was prepared with the following construction:

| Composition | Thickness (mils) |
|---|---|
| PFA-no filler | 0.05 |
| PTFE - no filler | 0.25 |
| PTFE with 28 Vol % TiO₂ | 0.40 |
| PTFE with 2 Vol % Carbon Black | 0.15 |
| FEP - no filler | 0.05 |
| Total (10.9 Vol % TiO₂) | 0.90 |

| | Dielectric | WVTR | | Reflectance | Color | |
|---|---|---|---|---|---|---|
| | Strength | (g/m 2/ | Opacity | (%) | L*A*B* (L*) | |
| | (kV) | day) | (%) | Side 1 | Side 1 | Side 2 |
| Ex 8 | 3.0 | 14 | 98.8 | 67.7 | 87.1 | 7.7 |

Example 4 through 8 were tested as follows: Dielectric break down strength was measured according to ASTM D3755, Standard Test Method for Dielectric Breakdown Voltage and Dielectric Strength of Solid Electrical Insulating Materials Under Direct-Voltage Stress; Solar Reflectance was measured according to ASTM E424, Standard Test Methods for Solar Energy Transmittance and Reflectance (Terrestrial) of Sheet Materials; Water vapor transmission rate was measured according to ASTM F1249, Water Vapor Transmission Rate Through Plastic Film and Sheeting Using a Modulated Infrared Sensor; and Opacity was measured according to ASTM method E424.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A film comprising:
a nonfibrillated fluoropolymer matrix material;
a particulate filler material wherein none of the particles of the particulate filler material exhibit a single linear dimension greater than 10 μm; and wherein
the fluoropolymer matrix material and particulate filler material are included in the composition in relative amounts effective to provide a composite film including less than 15 volume percent filler material.

2. The film of claim 1, wherein the fluoropolymer is selected from polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, tetrafluoroethylene/hexafluoropropylene copolymers, tetrafluoroethylene-perfluoro(alkyl vinyl ether) copolymers or mixtures thereof.

3. An optoelectronic device comprising:
an optoelectronic component and the film of claim 2, wherein the optoelectronic component and the film are packaged together.

4. The optoelectronic device of claim 3, wherein the film is a backsheet to the optoelectronic component.

5. A film comprising:
a nonfibrillated fluoropolymer matrix material;
a particulate filler material wherein none of the particles of the particulate filler material exhibit a single linear dimension greater than 10 μm; and wherein
the fluoropolymer matrix material and particulate filler material are included in the composition in relative amounts effective to provide a composite film including greater than 15 volume percent filler material.

6. The film of claim 5, wherein the fluoropolymer is selected from polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, tetrafluoroethylene/hexafluoropropylene copolymers, tetrafluoroethylene-perfluoro(alkyl vinyl ether) copolymers or mixtures thereof.

7. An optoelectronic device comprising:
an optoelectronic component and the film of claim 6, wherein the optoelectronic component and the film are packaged together.

8. The optoelectronic device of claim 7, wherein the layer film is a backsheet to the optoelectronic component.

9. A multilayer film comprising:
a first fluoropolymer film;
a second film comprising a nonfibrillated fluoropolymer matrix material;
a particulate filler material wherein none of the particles of the particulate filler material exhibit a single linear dimension greater than 10 μm; and wherein
the fluoropolymer matrix material and particulate filler material are included in the composition in relative amounts effective to provide a composite film including less than 15 volume percent filler material; and
a third fluoropolymer film disposed on the second film.

10. The multilayer film of claim 9, wherein the fluoropolymer matrix material is selected from polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, tetrafluoroethylene/hexafluoropropylene copolymers, tetrafluoroethylene-perfluoro(alkyl vinyl ether) copolymers or mixtures thereof.

11. The multilayer film of claim 10, wherein the fluoropolymer layers are each independently selected from polytetrafluoroethylene (PTFE), tetrafluoroethylene-perfluoro(alkyl vinyl ether) copolymers (PFA), ethylene/tetrafluoroethylene copolymers (ETFE), fluorinated ethylene propylene copolymers (FEP), polyvinylidenefluoride (PVDF), polychlorotrifluoroethlylene (PCTFE) or mixtures thereof.

12. An optoelectronic device comprising:
an optoelectronic component and the multilayer film of claim 11, wherein the optoelectronic component and the film are packaged together.

13. The optoelectronic device of claim 12, wherein the multilayer film is a backsheet to the optoelectronic component.

14. A multilayer film comprising:
a first fluoropolymer film;
a second film comprising; a nonfibrillated fluoropolymer matrix material;
a particulate filler material wherein none of the particles of the particulate filler material exhibit a single linear dimension greater than 10 μm; and wherein
the fluoropolymer matrix material and particulate filler material are included in the composition in relative amounts effective to provide a composite film including greater than 15 volume percent filler material; and
a third fluoropolymer film disposed on the second film.

15. The multilayer film of claim 14, wherein the fluoropolymer matrix material is selected from polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, tetrafluoroethylene/hexafluoropropylene copolymers, tetrafluoroethylene-perfluoro(alkyl vinyl ether) copolymers or mixtures thereof.

16. The multilayer film of claim 15, wherein the fluoropolymer layers are each independently selected from polytetrafluoroethylene (PTFE), tetrafluoroethylene-perfluoro(alkyl vinyl ether) copolymers (PFA), ethylene/tetrafluoroethylene copolymers (ETFE), fluorinated ethylene propylene copolymers (FEP), polyvinylidenefluoride (PVDF), polychlorotrifluoroethlylene (PCTFE) or mixtures thereof.

17. An optoelectronic device comprising:
an optoelectronic component and the multilayer film of claim 16, wherein the optoelectronic component and the multilayer film are packaged together.

18. A process to prepare a multilayer film comprising the steps:
coating a casting composition onto a support, the casting composition comprising:
a carrier;
a nonfibrillated fluoropolymer matrix material;
a particulate filler material; and
wherein the fluoropolymer matrix material and particulate filler material are included in the composition in relative amounts effective to provide a composite film;
contacting the composite film with a second casting composition, wherein the second casting composition comprises:
a carrier; and
polymeric matrix material, thereby providing a multilayer film; and
further contacting the multilayer film with a third casting composition, wherein the third casting composition comprises:
a carrier; and
a polymeric matrix material, thereby providing a 3 layer multilayer film wherein the composite layer is in between the first and third layers.

19. The method of claim 18, further comprising a step of coating the composite film with one or more casting compositions comprising
a carrier;
a nonfibrillated fluoropolymer matrix material;
a particulate filler material; and
wherein the polymer matrix material and particulate filler material are included in the composition in relative amounts effective to provide a multilayer composite film layer.

20. The method of claim 19, further comprising contacting the multilayer composite film with a casting composition, wherein the casting composition comprises:
a carrier; and
fluoropolymeric material, thereby providing a multilayer film with a first outer layer.

21. The method of claim 20, further comprising further contacting the multilayer composite film with a casting composition, wherein the casting composition comprises:
a carrier; and
a fluoropolymeric material, thereby providing a multilayer film with a second outer layer wherein the multilayer composite particle layers are in between the two outer layers.

22. The method of claim 21, further comprising the step of:
subjecting an outer layer to a charged particle process.

23. The method of claim 22, wherein the charged particle process is corona discharge or plasma treatment.

24. A multilayer film comprising:
a first layer comprising an aqueous or solvent castable fluoropolymer or mixtures thereof;
a second layer disposed upon the first layer, the second layer comprising an aqueous or solvent castable fluoropolymer or mixtures thereof and a particulate filler material or mixtures thereof, wherein
the particulate filler material is present in the castable fluoropolymer in a range of from about 10% by volume to about 45% by volume; and
a third layer disposed upon the second layer comprising an aqueous or solvent castable fluoropolymer or mixtures thereof.

25. The multilayer film of claim 24, further including a fourth layer comprising an aqueous or solvent castable fluoropolymer or mixtures thereof disposed upon the first layer.

26. The multilayer film of claim 25, further including a fifth layer comprising an aqueous or solvent castable fluoropolymer or mixtures thereof disposed upon the third layer.

27. The multilayer film of claim 26, wherein the fourth and fifth layers are selected from polytetrafluoroethylene (PTFE), tetrafluoroethylene-perfluoro(alkyl vinyl ether) copolymers (PFA), ethylene/tetrafluoroethylene copolymers (ETFE), fluorinated ethylene propylene copolymers (FEP), polyvinylidenefluoride (PVDF), polychlorotrifluoroethlylene (PCTFE) or mixtures thereof.

28. The multilayer film of claim 24, wherein the dielectric break down strength (kV) is greater than 3 kV measured by ASTM method D3755.

29. The multilayer film of claim 24, wherein the solar reflectance is greater than 70% measured by ASTM method E424.

30. The multilayer film of claim 24, wherein the water vapor transmission rate is less than about 20 g/m²/day measured by ASTM method F1249.

31. The multilayer film of claim 24, wherein the light opacity is greater than about 80% measured by ASTM method E424.

32. A multilayer film of claim 24, wherein the solar reflectance within the infrared range is greater than 30%.

33. A multilayer film of claim 24, wherein the solar reflectance within the infrared range is greater than 50%.

34. A multilayer film of claim 24, wherein the solar reflectance within the infrared range is greater than 70%.

35. A multilayer film of claim 25, wherein one side has high reflectivity of greater than 65% and the total opacity of the film is greater than 90%.

36. A multilayer film of claim 25, wherein one side has high reflectivity of greater than 70% and the total opacity of the film is greater than 95%.

37. A multilayer film of claim 25, wherein one side has high reflectivity of greater than 75% and the total opacity of the film is greater than 99%.
